(19) United States
(12) Patent Application Publication
(10) Pub. No.: US 2010/0058209 A1
(43) Pub. Date: Mar. 4, 2010

(54) BUSINESS CARD GENERATION DURING DOMAIN NAME REGISTRATION

(75) Inventor: Warren Adelman, Scottsdale, AZ (US)

Correspondence Address: GO DADDY GROUP, INC., 14455 NORTH HAYDEN ROAD, SUITE 219, SCOTTSDALE, AZ, 85260, US

(73) Assignee: The Go Daddy Group, Inc., Scottsdale, AZ (US)

(21) Appl. No.: 12/202,919

(22) Filed: Sep. 2, 2008

(51) Int. Cl. G06F 3/048

(52) U.S. Cl. 715/764

(57) ABSTRACT

Methods of the present inventions allow for generating a business card during domain name registration. An exemplary method may comprise the step of generating a business card containing information received during the process of registering a domain name to a registrant and, perhaps, providing the business card to the registrant. The information may comprise the registrant's name, title, address, telephone number, facsimile number, domain name, URL, email address, business name, business logo, and/or business tagline.

### CROSS REFERENCE TO RELATED PATENT APPLICATIONS

This patent application is related to U.S. patent application Ser. No. ______ entitled: “Systems for Generating Business Cards during Domain Name Registration” concurrently filed herewith and also assigned to The Go Daddy Group, Inc.

### FIELD OF THE INVENTION

The present inventions generally relate to domain name registration and, more particularly, business card generation during domain name registration.

### BACKGROUND OF THE INVENTION

A network is a collection of links and nodes (e.g., multiple computers and/or other devices connected together) arranged so that information may be passed from one part of the network to another over multiple links and through various nodes. Examples of networks include the Internet, the public switched telephone network, the global Telex network, computer networks (e.g., an intranet, an extranet, a local-area network, or a wide-area network), wired networks, wireless networks, and/or any combination thereof.

The Internet is a worldwide network of computers and computer networks arranged to allow the easy and robust exchange of information between computer users. Hundreds of millions of people around the world have access to computers connected to the Internet via Internet Service Providers (ISPs). Content providers place multimedia information (e.g., text, graphics, audio, video, animation, and other forms of data) at specific locations on the Internet referred to as webpages. Websites comprise a collection of connected, or otherwise related, webpages. The combination of all the websites and their corresponding webpages on the Internet is generally known as the World Wide Web (WWW) or simply the Web.

Prevalent on the Web are multimedia websites, some of which may offer and sell goods and services to individuals and organizations. Websites may consist of a single webpage, but typically consist of multiple interconnected and related webpages. Websites, unless extremely large and complex or have unusual traffic demands, typically reside on a single server and are prepared and maintained by a single individual or entity. Menus and links may be used to move between different webpages within the website or to move to a different website as is known in the art. The interconnectivity of webpages enabled by the Internet can make it difficult for Internet users to tell where one website ends and another begins.

Websites may be created using HyperText Markup Language (HTML) to generate a standard set of tags that define how the webpages for the website are to be displayed. Users of the Internet may access content providers' websites using software known as an Internet browser, such as MICROSOFT INTERNET EXPLORER or MOZILLA FIREFOX. After the browser has located the desired webpage, it requests and receives information from the webpage, typically in the form of an HTML document, and then displays the webpage content for the user. The user then may view other webpages at the same website or move to an entirely different website using the browser.

Browsers are able to locate specific websites because each website, resource, and computer on the Internet has a unique Internet Protocol (IP) address. Presently, there are two standards for IP addresses. The older IP address standard, often called IP Version 4 (IPv4), is a 32-bit binary number, which is typically shown in dotted decimal notation, where four 8-bit bytes are separated by a dot from each other (e.g., 64.202.167.32). The notation is used to improve human readability. The newer IP address standard, often called IP Version 6 (IPv6) or Next Generation Internet Protocol (IPng), is a 128-bit binary number. The standard human readable notation for IPv6 addresses presents the address as eight 16-bit hexadecimal words, each separated by a colon (e.g., 2EDC:BA98:0332:0000:CF8A:000C:2154:7313).

IP addresses, however, even in human readable notation, are difficult for people to remember and use. A Uniform Resource Locator (URL) is much easier to remember and may be used to point to any computer, directory, or file on the Internet. A browser is able to access a website on the Internet through the use of a URL. The URL may include a Hypertext Transfer Protocol (HTTP) request combined with the website's Internet address, also known as the website's domain name. An example of a URL with a HTTP request and domain name is: http://www.companyname.com. In this example, the “http” identifies the URL as a HTTP request and the “companyname.com” is the domain name.

Domain names are much easier to remember and use than their corresponding IP addresses. The Internet Corporation for Assigned Names and Numbers (ICANN) approves some Generic Top-Level Domains (gTLD) and delegates the responsibility to a particular organization (a “registry”) for maintaining an authoritative source for the registered domain names within a TLD and their corresponding IP addresses. For certain TLDs (e.g., .biz, .info, .name, and .org) the registry is also the authoritative source for contact information related to the domain name and is referred to as a “thick” registry. For other TLDs (e.g., .com and .net) only the domain name, registrar identification, and name server information is stored within the registry, and a registrar is the authoritative source for the contact information related to the domain name. Such registries are referred to as “thin” registries. Most gTLDs are organized through a central domain name Shared Registration System (SRS) based on their TLD.

The process for registering a domain name with .com, .net, .org, and some other TLDs allows an Internet user to use an ICANN-accredited registrar to register their domain name. For example, if an Internet user, John Doe, wishes to register the domain name “mycompany.com,” John Doe may initially determine whether the desired domain name is available by contacting a domain name registrar. The Internet user may make this contact using the registrar's webpage and typing the desired domain name into a field on the registrar's webpage created for this purpose. Upon receiving the request from the Internet user, the registrar may ascertain whether “mycompany.com” has already been registered by checking the SRS database associated with the TLD of the domain name. The results of the search then may be displayed on the webpage to thereby notify the Internet user of the availability of the domain name. If the domain name is available, the Internet user may proceed with the registration process. Otherwise, the Internet user may keep selecting alternative domain names until an available domain name is found. Domain names are typically registered for a period of one to ten years with first rights to continually re-register the domain name.

For Internet users and businesses alike, the Internet continues to be increasingly valuable. More people use the Web for everyday tasks, from social networking, shopping, banking, and paying bills to consuming media and entertainment. E-commerce is growing, with businesses delivering more services and content across the Internet, communicating and collaborating online, and inventing new ways to connect with each other.

Internet users routinely send electronic messages (also known as electronic mail or email) to each other over a network, such as the Internet. Email may contain, for example, text, images, links, and attachments. Email is one of the most widely used methods of communication over the Internet due to the variety of data that may be transmitted, large number of available recipients, speed, low cost and convenience.

Emails may be sent, for example, between friends, family members, coworkers, customers, and businesses thereby substituting for traditional letters and office correspondences in many situations. Emails travel across the Internet, typically passing from server to server, at amazing speeds achievable only by electronic data. The Internet provides the ability to send an email anywhere in the world, often in less than a few seconds. Delivery times are continually being reduced as the Internet's ability to transfer electronic data improves.

Internet users may send and read their email messages using either desktop computer programs, such as MICROSOFT OUTLOOK (a desktop or client-based system), or via websites connected to mail servers (Web-based email systems). With either system, a user's email address may include a domain name registered to the user (e.g., johndoe@companyname.com).

Some Internet users, typically those that are larger and more sophisticated, may provide their own hardware, software, and connections to the Internet. But many Internet users either do not have the resources available or do not want to create and maintain the infrastructure necessary to host their own websites. To assist such individuals (or entities), hosting companies exist that offer website hosting services. These hosting service providers typically provide the hardware, software, and electronic communication means necessary to connect multiple websites to the Internet. A single hosting service provider may literally host thousands of websites on one or more hosting servers.

Applicant has noticed that, however, that presently-existing systems and methods do not allow domain name registrants to, contemporaneously with their domain name registration, obtain business cards containing information related to their domain name. Should a domain name registrant desire business cards containing domain name-related information (e.g., URL or email address), he must first complete the domain name registration process and subsequently order—from a third-party—business cards containing the desired information. For the foregoing reasons, there is a need for the systems and methods for business card generation during domain name registration as described herein.

### SUMMARY OF THE INVENTION

The limitations cited above and others are substantially overcome through the systems and methods disclosed herein, which allow for business card generation during domain name registration, and related functionality.

An example embodiment of a method for generating a business card during domain name registration may comprise the step of generating a business card containing information received during the process of registering a domain name to a registrant and, perhaps, providing the business card to the registrant. The information may comprise the registrant's name, title, address, telephone number, facsimile number, domain name, URL, email address, business name, business logo, and/or business tagline.

An example embodiment of a system for generating a business card during domain name registration may comprise a website (having one of more fields for receiving at least one requested domain name and a plurality of information from a prospective domain name registrant) hosted on at least one server, a domain name registration module running on at least one server and registering (if available) the domain name to the registrant, a business card generation and delivery module running on at least one server and generating a business card (if the domain name is registered to the registrant) containing some of the information received, and a network communicatively coupling the website, domain name registration module, and business card generation and delivery module.

The above features and advantages of the present inventions will be better understood from the following detailed description taken in conjunction with the accompanying drawings.

### BRIEF DESCRIPTION OF THE DRAWINGS

FIG. 1 is a flow diagram illustrating a possible embodiment of a method for generating a business card during domain name registration.

FIG. 2a illustrates a possible embodiment of a business card generated during domain name registration.

FIG. 2b illustrates a possible embodiment of a business card generated during domain name registration.

FIG. 3 is a flow diagram illustrating a possible embodiment of a method for generating a business card during domain name registration.

FIG. 4 is a flow diagram illustrating a possible embodiment of a method for generating a business card during domain name registration.

FIG. 5 is a flow diagram illustrating a possible embodiment of a method for generating a business card during domain name registration.

FIG. 6 is a flow diagram illustrating a possible embodiment of a method for generating a business card during domain name registration.

FIG. 7 is a flow diagram illustrating a possible embodiment of a method for generating a business card during domain name registration.

FIG. 8 is a flow diagram illustrating a possible embodiment of a method for generating a business card during domain name registration.

FIG. 9 is a flow diagram illustrating a possible embodiment of a method for generating a business card during domain name registration.

FIG. 10 is a flow diagram illustrating a possible embodiment of a method for generating a business card during domain name registration.

FIG. 11 illustrates a possible embodiment of a system for generating a business card during domain name registration.

FIG. 12 illustrates a possible embodiment of a system for generating a business card during domain name registration.

### DETAILED DESCRIPTION

The present inventions will now be discussed in detail with regard to the attached drawing figures which were briefly described above. In the following description, numerous specific details are set forth illustrating the Applicant's best mode for practicing the inventions and enabling one of ordinary skill in the art to make and use the inventions. It will be obvious, however, to one skilled in the art that the present inventions may be practiced without many of these specific details. In other instances, well-known machines, structures, and method steps have not been described in particular detail in order to avoid unnecessarily obscuring the present inventions. Unless otherwise indicated, like parts and method steps are referred to with like reference numerals.

Methods for Generating Business Cards during Domain Name Registration

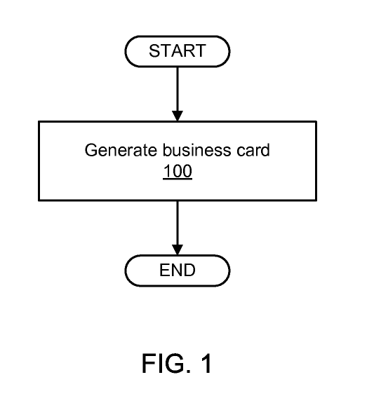

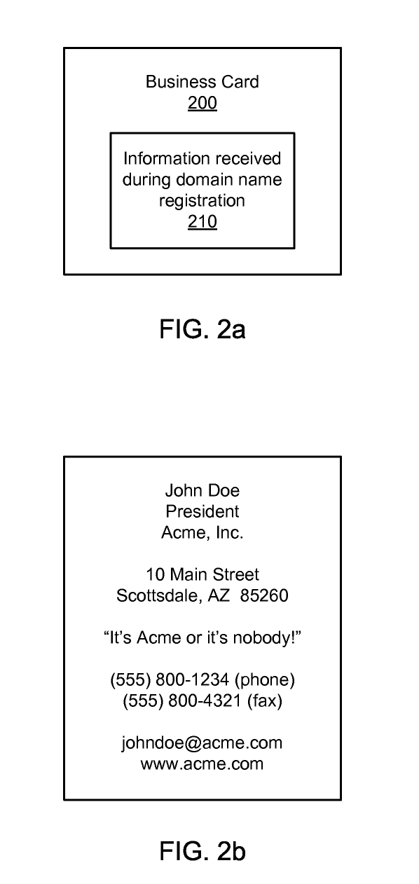

FIG. 1 illustrates a streamlined embodiment of a business card generation method that may comprise the step of generating a business card containing information received during the process of registering a domain name to a registrant (Step 100). As illustrated in FIGS. 2a and 2b, the business card 200 may comprise any human or computer-readable medium capable of conveying information about a business, entity, organization, or individual. For example, the business card could comprise a printed document, such as the traditional business card containing information printed on wallet-sized card stock. Printed documents of all shapes and sizes and of all printed media types (e.g., paper, stationary, card stock, etc.) also may be used.

Alternatively, the business card 200 may comprise an information-bearing electronic document. A non-limiting example may include an electronic document that, when rendered on a computer screen or other display device, appears similar to a traditional printed business card 200. The electronic document may also appear in an unconventional form that displays the same or similar information. Such electronic documents may be generated by proprietary, commercially-available, open-source, or any other computer graphics software. Electronic business cards may be formatted to print on a printer, or designed to be used exclusively in electronic format. Such an electronic business card 200 may comprise any information-bearing computer file in any computer-readable file format including, but not limited to, pdf, image, word processing, and/or html files. Data file types that integrate well with known electronic calendaring systems also may be used, including, but not limited to, iCalendar, vCalendar, vCal, or any other specified format that may be compatible with an electronic calendar. An electronic business card 200 also could comprise a webpage resolving from a domain name that displays information, such as a parked webpage. In another embodiment, a business card 200 may comprise a hybrid physical and electronic medium for communicating information, such as a printed card with embedded electronic media (e.g., flash memory) or, perhaps, a wallet-sized CD-ROM card.

As explained above, the business card 200 may contain information received during the process of registering a domain name to a registrant. Domain name registration may be accomplished by any domain name registration method known in the art or developed in the future, perhaps via a website-enabled domain name purchase and registration system, such as that described in detail above and/or may be available on GODADDY.COM's website. Alternatively, domain name registration may be accomplished via human to human communication, perhaps via a telephone call or in-person meeting. Domain names may be registered by, as non-limiting examples, any individual or entity including, but not limited to a domain name registry, domain name registrar, hosting provider, and/or software application developer or distributor.

Irrespective of the domain name registration method used, a plurality of information may be collected from a prospective registrant during the registration process. Such information may be collected, among other methods, via data entry fields on a website and/or during a question and answer session with a customer service representative. As non-limiting examples, the collected information may comprise the registrant's name, title, address, telephone number, facsimile number, domain name, URL, email address, business name, business logo, and/or business tagline. The URL and/or email address may or may not include the registered domain name (e.g., www.acme.com or johndoe@acme.com). As shown in FIG. 2a, the business card 200 may include any such information 210 received from any source in connection with the process of domain name registration. FIG. 2b illustrates an example business card 200 containing similar information 210.

Once the plurality of information 210 is received from the registrant, a business card 200 containing at least some of the information 210 may be generated, perhaps by at least one microprocessor executing a plurality of instructions stored on at least one computer-readable media. This may be accomplished automatically after at least some information 210 is received from the registrant. As a non-limiting example, this method may be performed by a server executing specifically-written scripts or other software stored in memory accessible by the server.

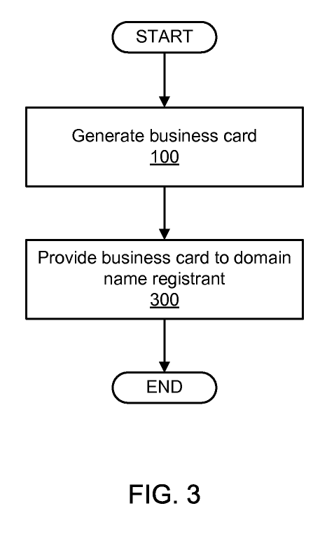

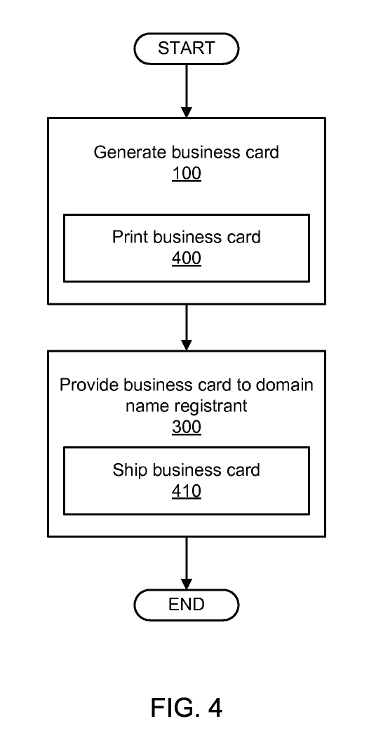

FIG. 3 illustrates an example embodiment that, in addition to the step of generating a business card discussed above (Step 100), includes the step of providing the business card 200 to the registrant (Step 300). As illustrated in FIG. 4, if the business card 200 comprises a printed document, it may be generated (Step 100) by printing the business card 200-perhaps with a printer communicatively coupled to the server described above (Step 400)-and provided to the registrant (Step 300) by physically shipping the business card 200 to the registrant (Step 410), perhaps via the United State Postal Service or a commercial shipping service.

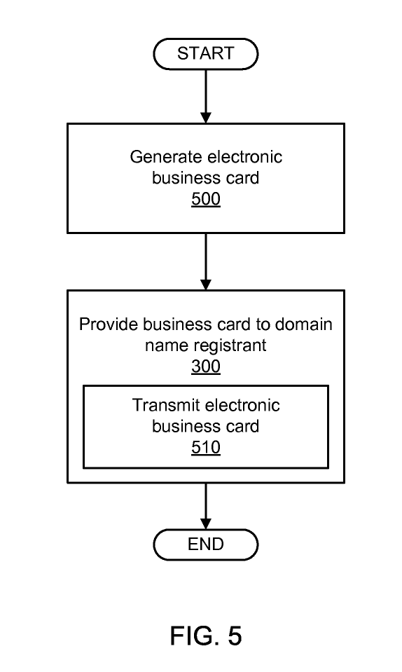

As illustrated in FIG. 5, after an electronic business card 200 is generated (Step 500), it may be provided to the registrant (Step 300) by, as a non-limiting example, transmitting the electronic document over a network (Step 510). The electronic business card 200 may be transmitted to the registrant via any means of transferring data known in the art or developed in the future including, but not limited to, email. Such data transfer methods can generally be classified in two categories: (1) “pull-based” data transfers where the receiver initiates a data transmission request; and (2) “push-based” data transfers where the sender initiates a data transmission request. Both types are expressly included in the embodiments illustrated herein, which also may include transparent data transfers over network file systems, explicit file transfers from dedicated file-transfer services like FTP or HTTP, distributed file transfers over peer-to-peer networks, file transfers over instant messaging systems, file transfers between computers and peripheral devices, and/or file transfers over direct modem or serial (null modem) links, such as XMODEM, YMODEM and ZMODEM. Data streaming technology also may be used to effectuate data transfer. A data stream may be, for example, a sequence of digitally encoded coherent signals (packets of data) used to transmit or receive information that is in transmission. Any data transfer protocol known in the art or developed in the future may be used including, but not limited to: (1) those used with TCP/IP (e.g., FTAM, FTP, HTTP, RCP, SFTP, SCP, or FASTCopy); (2) those used with UDP (e.g., TFTP, FSP, UFTP, or MFTP); (3) those used with direct modem connections; (4) HTTP streaming; (5) Tubular Data Stream Protocol (TDSP); (6) Stream Control Transmission Protocol (SCTP); and/or (7) Real Time Streaming Protocol (RTSP).

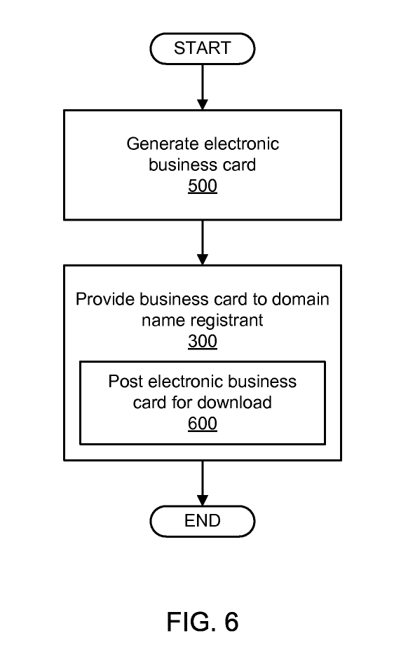

As illustrated in FIG. 6, an electronic business card 200 also may be provided to a domain name registrant (Step 300) by posting the electronic document (i.e., business card) in a storage area accessible to the registrant via a network (Step 600). As a non-limiting example, the electronic business card 200 may be stored with an online file storage service, such as GODADDY.COM's ONLINE FILE FOLDER, which may provide server-side network file storage for personal backup, file access, and/or file distribution. Such services may allow a registrant to access and download files to a client or, perhaps, another network storage device.

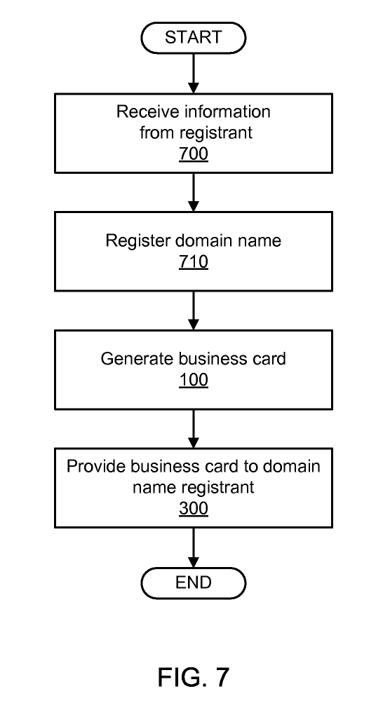

FIG. 7 illustrates another example embodiment of a business card generation method that may comprise the steps of receiving a plurality of information 210 from a registrant during the process of registering a domain name (Step 700), registering the domain name to the registrant (Step 710), generating a business card 200 containing at least one piece of information 210 received during the domain registration process (Step 100), and providing the business card to the registrant (Step 300).

Information 210 may be received from the registrant (Step 700) at any point in time, as long as the receipt of the information 210 is at least tangentially related to the process of registering a domain name. Information 210 may be received via any of the methods described above and may comprise-as non-limiting examples—the registrant's name, title, address, telephone number, facsimile number, domain name, URL, email address, business name, business logo, and/or business tagline. The URL and/or email address may or may not include the registered domain name (e.g., www.acme.com or johndoe acme.com).

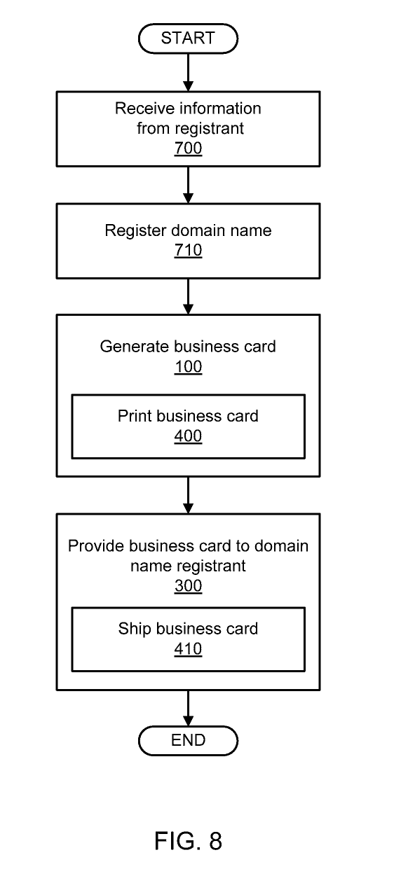

The domain name may be registered to the registrant (Step 710) by any domain name registration method known in the art or developed in the future, including those described in detail above. Business cards 200 may be generated (Step 100) and provided to the registrant (Step 300) as described above. The embodiment illustrated in FIG. 8 expands upon the embodiment shown in FIG. 7 in that, where the business card 200 comprises a printed document, it may be generated (Step 100) by printing the business card 200—perhaps with a printer communicatively coupled to the server described above (Step 400)—and provided to the registrant (Step 300) by physically shipping the business card 200 to the registrant (Step 410), perhaps via the United State Postal Service or a commercial shipping service.

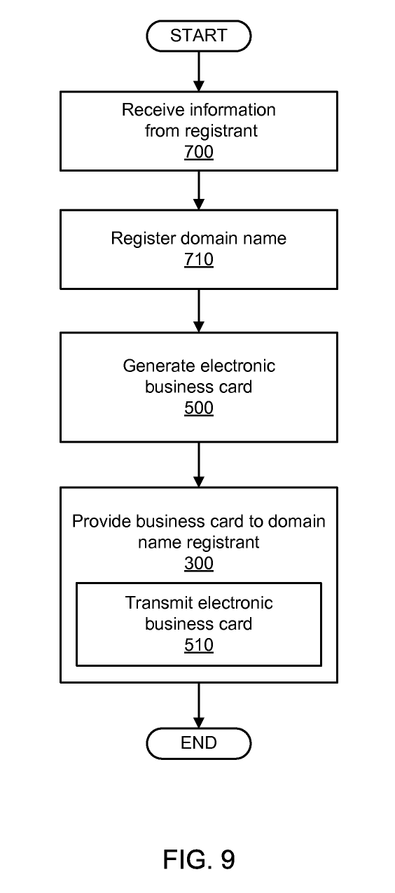

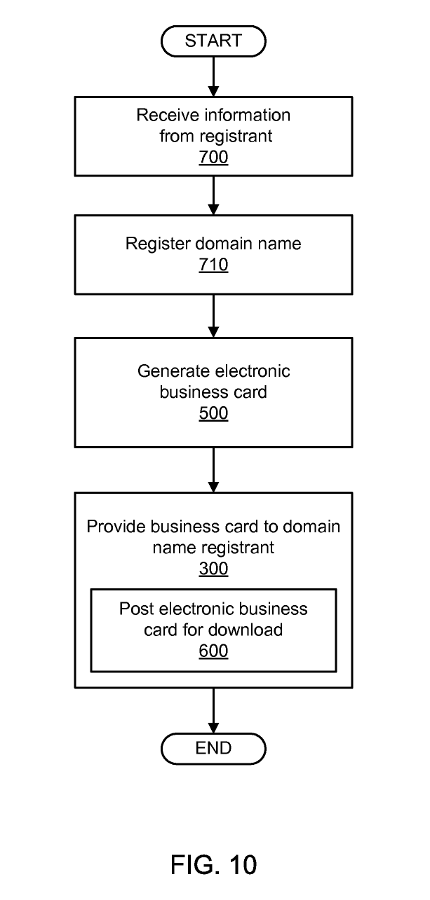

The embodiment illustrated in FIG. 9 expands upon the embodiment shown in FIG. 7 in that, an electronic business card 200 is generated (Step 500) that may be provided to the registrant (Step 300) by, as a non-limiting example, transmitting the electronic document over a network (Step 510). The electronic business card 200 may be transmitted to the registrant as described in detail above. Alternatively, and as illustrated in FIG. 10, an electronic business card 200 also may be provided to a domain name registrant (Step 300) by posting the electronic document (i.e., business card) in a storage area accessible to the registrant via a network (Step 600).

Systems for Generating Business Cards during Domain Name Registration

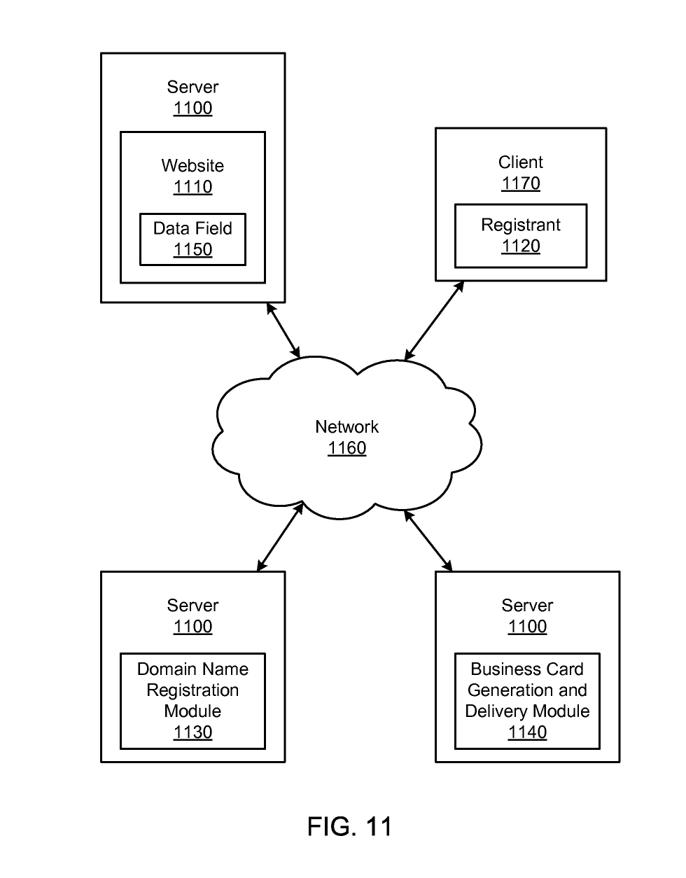

FIG. 11 illustrates a possible embodiment of a system for generating business cards during domain name registration. This example embodiment may comprise a website 1110 hosted on at least one server 1100. The at least one server 1100 and/or any other server described herein, could be any computer or program that provides services to other computers, programs, or users either in the same computer or over a computer network. As non-limiting examples, the at least one server 1100 could be an application, communication, mail, database, proxy, fax, file, media, web, peer-to-peer, or standalone server and may use any server format known in the art or developed in the future (possibly a shared hosting server, a virtual dedicated hosting server, a dedicated hosting server, or any combination thereof).

The website 1110 may have one or more fields 1150 for receiving at least one requested domain name and a plurality of information 210 from a prospective domain name registrant 1120. The website 1110 may comprise any collection of data and/or files accessible via a browser on a client 1170 having access to the network 1160. Examples of clients 1160 that may be used include a desktop computer, a laptop computer, a hand held computer, a terminal, a television, a television set top box, a cellular phone, a wireless phone, a wireless hand held device, an Internet access device, a rich client, thin client, or any other client functional with a client/server computing architecture. The fields 1150 on the website 1110 may comprise a box on a webpage allowing a registrant (or other user) to enter information 210. Alternatively, the registrant 1120 may select information 210 from a list, perhaps in drop-down menu or matrix form.

A domain name registration module 1130 may be stored in the memory of—and run on—at least one server 1100. If the domain name is available, the domain name registration module 1130 may register the domain name to the registrant 1120. The domain name registration module 1130 may comprise software and/or scripts containing instructions that, when executed by a microprocessor on a server or client, cause the microprocessor to register a domain name to a registrant 1120, if available. It may comprise any domain name registration system known in the art or developed in the future including, but not limited to, a website-enabled domain name purchase and registration system, such as that described in detail above and/or may be available on GODADDY.COM's website.

The embodiment illustrated in FIG. 11 also may comprise a business card generation and delivery module 1140 that may be stored in the memory of—and run on—at least one server 1100. If the domain name is registered to the registrant 1120, the business card generation and delivery module 1140 also may generate a business card 200 containing at least some of the information 210 received from the domain name registrant 1120. The business card generation and delivery module 1140 may comprise software and/or scripts containing instructions that, when executed by a microprocessor on a server or client, cause the microprocessor to generate a business card 200 containing at least one of said plurality of information 210.

As described above, the business card 200 may comprise any human or computer-readable medium capable of conveying information about a business, entity, organization, or individual. For example, the business card could comprise a printed document, such as the traditional and well-known business card containing information printed on wallet-sized card stock. In such an embodiment, the business card generation and delivery module 1140 may generate an electronic, printer-friendly file for transmission to the registrant 1120 via the network 1160. Once received, the registrant 1120 may print the business card 200 locally. Alternatively, the business card generation and delivery module 1140 may cause a printer that may be communicatively coupled to the network to print the business card 200. With such an embodiment, the business card 200 may be shipped to the registrant 1120, perhaps via the United State Postal Service or a commercial shipping service.

Alternatively, the business card 200 may comprise an information-bearing electronic document that may comprise, as a non-limiting example, one of the computer files described in detail above that may be generated by the business card generation and delivery module 1140. With this embodiment, the business card generation and delivery module 1140 may cause the server 1110 to provide the business card 200 to the domain name registrant 1120 by transmitting the electronic file over the network 1160 as described in detail above. Alternatively, the business card generation and delivery module 1140 may cause the server 1110 to post the electronic document business card 200 in a storage area accessible to the registrant 1120 via the network 1160, as also described in detail above.

The network 1160 may communicatively couple the servers 1100, the domain name registration module 1130, and the business card generation and delivery module 1140. The example embodiments herein place no limitation on network 1160 configuration or connectivity. Thus, as non-limiting examples, the network 1160 could comprise the Internet, the public switched telephone network, the global Telex network, computer networks (e.g., an intranet, an extranet, a local-area network, or a wide-area network), wired networks, wireless networks, or any combination thereof.

The registrant 1120 may access the illustrated system via a client 1170 communicatively coupled to the network 1160. The servers 1100, domain name registration module 1130, business card generation and delivery module 1140, and client 1170 may be communicatively coupled to the network 1160 via any method of network connection known in the art or developed in the future including, but not limited to wired, wireless, modem, dial-up, satellite, cable modem, Digital Subscriber Line (DSL), Asymmetric Digital Subscribers Line (ASDL), Virtual Private Network (VPN), Integrated Services Digital Network (ISDN), X.25, Ethernet, token ring, Fiber Distributed Data Interface (FDDI), IP over Asynchronous Transfer Mode (ATM), Infrared Data Association (IrDA), wireless, WAN technologies (T1, Frame Relay), Point-to-Point Protocol over Ethernet (PPPoE), and/or any combination thereof.

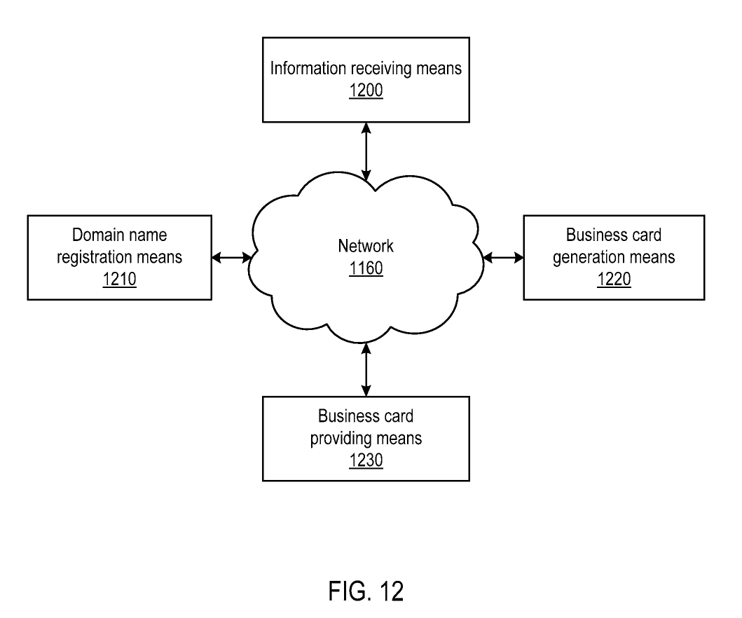

FIG. 12 illustrates yet another embodiment of a system for generating business cards during domain name registration. This example embodiment may comprise means for receiving 1200 a plurality of information 210 from a registrant 1120 during the process of registering a domain name, means for registering 1210 the domain name to the registrant 1120, means for generating 1220 a business card 200 containing at least some of the collected information 210, means for providing 1230 the business card 200 to the registrant 1120, and a network 1160 communicatively coupling said means for receiving 1200, said means for registering 1210, said means for generating 1220, and said means for providing 1230.

The information receiving means 1200 may comprise any system for receiving information from any source during the process of registering a domain name to a registrant 1120 including, but not limited to the website 1110 described in detail above. As additional, non-limiting examples, the information receiving means 1200 also could comprise a telephone-based information collection system (automated or manned), an in-person interview, and/or or an automated or manual data entry system for collecting, sorting, and/or inputting information 210 received in any form from a prospective registrant.

The domain name registration means 1210 may comprise any system for registering a domain name to a registrant 1210 known in the art, or developed in the future including, but not limited to, a website-enabled domain name purchase and registration system, such as that described in detail above and/or may be available on GODADDY.COM's website.

The business card generation means 1220 may comprise any system for generating a business card 200 known in the art or developed in the future including, but not limited to, the domain name registration module 1130 described in detail above. With a printed business card 200 embodiment, any known system and/or method for printing business cards may be used. With an electronic business card 200 embodiment, any method of generating an electronic file bearing information 210 may be used. The business card providing means 1230 may comprise any system for providing the registrant 1120 with the generated business card 200, including those described in detail above.

The means for receiving 1200, said means for registering 1210, said means for generating 1220, and said means for providing 1230 may be communicatively coupled to the network 1160 via any method of network connection known in the art or developed in the future, including those discussed in detail above.

An Example Use of Systems and Methods for Generating Business Cards During Domain Name Registration

The systems and methods described herein may be used in many ways to, among other things, provide Internet users with business cards 200 that incorporate their newly-registered domain names. As a non-limiting example of how such systems and methods may be used, an Internet user (i.e., a prospective registrant 1120) may register a domain name (e.g., acme.com) by accessing a domain name registrar's website 1110, such as may be available on GODADDY.COM's website. In data fields 1150 available on the website, the registrant 1120 may enter a variety of requested information 210, such as a requested domain name (e.g., acme.com), the registrant's name (e.g., John Doe), and a preferred email address (e.g., johndoe@acme.com) (Step 700). If the registrant 1120 has a business, the provided information 210 also may include his business' name (e.g., Acme, Inc.), address, telephone number, facsimile number, and perhaps a corporate tagline (e.g., “It's Acme or it's nobody!”).

A domain name registration module 1130 on the domain name registrar's servers 1100 then may check the availability of acme.com and, if available, register the domain name to the registrant 1120 (Step 710). Meanwhile, a business card generation and delivery module 1140, also on the domain name registrar's servers 1100, may generate a business card 200 in the form of a pdf file containing, as illustrated in FIG. 2b, some of the information 210 received from the registrant 1120 (Step 500). Among other information 210, the business card may contain the registrant's 1120 newly-registered URL (e.g., www.acme.com) and/or email address (johndoe@acme.com). The pdf file may be configured in a printer-friendly format that will print in the proper size and shape on the registrant's 1120 printer. The business card generation and delivery module 1140 may then provide the business card 200 in pdf format to the registrant 1120 (Step 300) by transmitting it (Step 510) as an email attachment to the registrant's 1120 email address.

Other embodiments and uses of the above inventions will be apparent to those having ordinary skill in the art upon consideration of the specification and practice of the inventions disclosed herein. The specification and examples given should be considered exemplary only, and it is contemplated that the appended claims will cover any other such embodiments or modifications as fall within the true scope of the inventions.

The Abstract accompanying this specification is provided to enable the United States Patent and Trademark Office and the public generally to determine quickly from a cursory inspection the nature and gist of the technical disclosure and in no way intended for defining, determining, or limiting the present inventions or any of its embodiments.

The inventions claimed are:

1. A method performed by at least one microprocessor executing a plurality of instructions stored on at least one computer-readable media, said method comprising the step of:
generating a business card containing at least one of a plurality of information received during a process of registering a domain name to a registrant.

2. The method of claim 1, further comprising the step of providing said business card to said registrant.

3. The method of claim 2, wherein said at least one of said plurality of information is selected from the group consisting of said registrant's name, title, address, telephone number, facsimile number, domain name, URL, email address, business name, business logo, and business tagline.

4. The method of claim 3, wherein said URL comprises said domain name.

5. The method of claim 3, wherein said email address comprises said domain name.

6. The method of claim 3, wherein said business card comprises a printed document.

7. The method of claim 6, wherein said generating step comprises printing said business card with a printer.

8. The method of claim 7, wherein said providing step comprises shipping said business card to said registrant.

9. The method of claim 3, wherein said business card comprises an electronic document.

10. The method of claim 9, wherein said providing step comprises transmitting said electronic document to said registrant over a network.

11. The method of claim 9, wherein said providing step comprises posting said electronic document in a storage area accessible to said registrant via a network.

12. A method performed by at least one microprocessor executing a plurality of instructions stored on at least one computer-readable media, said method comprising the steps of:
A) receiving a plurality of information from a registrant during a process of registering a domain name;
B) registering said domain name to said registrant;
C) generating a business card containing at least one of said plurality of information; and
D) providing said business card to said registrant.

13. The method of claim 12, wherein said at least one of said plurality of information is selected from the group consisting of said registrant's name, title, address, telephone number, facsimile number, domain name, URL, email address, business name, business logo, and business tagline.

14. The method of claim 13, wherein said URL comprises said domain name.

15. The method of claim 13, wherein said email address comprises said domain name.

16. The method of claim 13, wherein said business card comprises a printed document.

17. The method of claim 16, wherein said generating step comprises printing said business card with a printer.

18. The method of claim 17, wherein said providing step comprises shipping said business card to said registrant.

19. The method of claim 13, wherein said business card comprises an electronic document.

20. The method of claim 19, wherein said providing step comprises means for transmitting said electronic document to said registrant over a network.

21. The method of claim 19, wherein said providing step comprises posting said electronic document in a storage area accessible to said registrant via a network.
